(19) United States
(12) Patent Application Publication
(10) Pub. No.: US 2007/0020370 A1
(43) Pub. Date: Jan. 25, 2007

(54) Fruit gum composition

(76) Inventor: Martin Schymura, Regensburg (DE)

Correspondence Address: NEEDLE & ROSENBERG, P.C., SUITE 1000, 999 PEACHTREE STREET, ATLANTA, GA, 30309-3915, US

(21) Appl. No.: 10/551,306

(22) PCT Filed: Mar. 11, 2004
(86) PCT No.: PCT/EP04/02483

§ 371 Date: Jun. 5, 2006

(30) Foreign Application Priority Data
Mar. 28, 2003 (DE) 103 14 453.6
Oct. 28, 2003 (DE) 103 50 140.1

(51) Int. Cl. A23L 1/05

(52) U.S. Cl. 426/573

(57) ABSTRACT

The invention relates to a fruit gum composition containing at least one sweetener, at least one gelatinizer and/or thickener, at least one souring agent, at least one colorant, at least one flavoring and at least one release and glazing agent or sugar-coating agent as a surface-treatment agent, wherein the fruit gum composition additionally contains L-carnitine and/or at least one L-carnitine salt and/or at least one L-carnitine salt mixture and/or at least one L-carnitine complex and/or at least one mixture of substances containing L-carnitine and/or at least one L-carnitine fumarate. The invention furthermore relates to a preparation method and to the use of the fruit gum composition.

The invention relates to a fruit gum composition containing at least one sweetener, at least one gelatinizer and/or thickener, at least one souring agent, at least one colorant, at least one flavoring and at least one release and glazing agent or sugar-coating agent as a surface-treatment agent, as claimed in the preamble of claim 1. The invention furthermore relates to a method of preparing such a fruit gum composition and to the use thereof.

Fruit gum compositions are generally known to the consumers of food supplements, for example in the form of the product “gummi bears”. Such fruit gum compositions usually exist as disclosed for example in EP 106 98 56 A1—as pleasant-tasting fruity confectionery products consisting of glucose syrup, sugar, gelatin, souring agents and colorants and flavorings. On account of the amount of glucose syrup and sugar, conventional fruit gum compositions have high calorie contents and in other respects a low nutritional value, which may lead to sportsmen and weight-conscious people in particular avoiding at least a high consumption of fruit gum compositions.

Furthermore, WO 02/00033 A1 discloses confectionery products which contain active ingredients in one or more carrier bodies in order to facilitate the admixture of active ingredients. This may be carried out for example by enclosing the active ingredients in the carrier bodies in liquid form. Moreover, such carrier bodies may be made visible to the consumers, and may be provided with a special shape, such as the shape of a cube for example. One of the active ingredients is carnitine.

Such capsule-like arrangements of active ingredients within confectionery products are aimed primarily at the esthetic effect with regard to the consumers and at advantages in respect of the admixture. No further details regarding the composition of carnitine can be found in WO 02/00033 A1.

Accordingly, it is an object of the present invention to provide a fruit gum composition, consumption of which provides weight-loss and energy to the respective consumer, in particular sportsmen. Furthermore, it is an object of the invention to provide a method of preparing such a fruit gum composition and the use thereof.

This object is achieved in terms of the product by the features of claim 1, in terms of the method by the features of claim 13 and in terms of the use by the features of claim 17.

One essential point of the invention is that, in a fruit gum composition containing at least one sweetener, at least one gelatinizer and/or thickener, at least one souring agent, at least one colorant, at least one flavoring and at least one release and glazing agent or sugar-coating agent as a surface-treatment agent, the fruit gum composition additionally contains L-carnitine and/or at least one L-carnitine salt and/or at least one L-carnitine salt mixture and/or at least one L-carnitine complex and/or at least one L-carnitine complex salt and/or at least one mixture of substances containing L-carnitine and/or at least one L-carnitine fumarate, and also the salts, complexes and complex salts thereof. When using L-carnitine, it is usually in a form which is at least sometimes crystalline, having the formula C₇H₁₅NO₃ or C₁₈H₃₆N₂O₁₂. The fact of adding L-carnitine and/or the salts, complexes, salt mixtures, fumarates thereof and mixtures of substances containing L-carnitine having such formulas means that the fruit gum composition, which exists for example in the form of gummi bears, considerably influences and assists the effects of fat burning and energy release in consumers. On account of these effects, the consumption of fruit gums becomes very attractive in particular to sportsmen, during and after training, and also to weight-conscious people. This is because the consumption of the fruit gum composition according to the invention, particularly in high amounts, leads to increased fat metabolism which in turn, particularly in conjunction with sufficient movement of the human body, results in increased fat burning within the human body. Also provided are a release of energy which assists the heart and muscles, improved performance, reduced stress reaction and recovery of the human body after physical exertion. Moreover, the fruit gum composition is also suitable as a food supplement for diets which are to be undertaken.

Advantageously, on account of the combination according to the invention of fruit gum with L-carnitine and/or the salts, complexes, complex salts, salt mixtures and fumarates thereof and also mixtures of substances containing L-carnitine, a metered uptake of L-carnitine throughout the day is practiced by the consumers. Fruit gum is moreover attractive to all age-groups. In particular, pleasant-tasting fruit gum compositions with a wide range of additional effects can be obtained by virtue of the combination of fruit gum with salts, complexes, complex salts, salt mixtures and/or fumarates of L-carnitine. For example, when L-carnitine is added to magnesium citrate, a magnesium mixture which has an advantageous effect on the muscles of a sportsman is obtained. Adding acetyl-L-carnitine hydrochloride, on the other hand, additionally provides a supplement for the human brain, which is important for cognitive performance.

According to one preferred embodiment, the L-carnitine is formed as a crystalline tartrate and added to the fruit gum composition. In this case, the crystalline tartrate has a molecular mass of 472.49 u.

Alternatively, the L-carnitine may be added to the fruit gum composition in pure crystalline form with a degree of purity of at least 99% and at most 1% of residual components, having a molecular mass of 161.20 u.

In both cases, the L-carnitine exists without any D-carnitine components which may have a toxic effect.

If the fruit gum composition according to the invention is shaped to form gummi bears, each gummi bear comprises 0-5000 mg, in particular 0-1000 mg, preferably 1 mg or 5 mg or 10 mg of L-carnitine when a conventional size of gummi bear is used. Of course, the amount of L-carnitine may be greater or smaller depending on the size of gummi bear.

The sweetener used is preferably glucose syrup, sugar, in particular sucrose, fructose, sorbitol and sugar substitutes, in particular isomalt and/or maltitol syrup, or a combination thereof.

Possible gelatinizers and/or thickeners are preferably gelatin and/or pectin and/or starch and/or modified starch and/or agar agar and/or gum arabic or mixtures thereof.

The souring agent used may be either citric acid and/or lactic acid and/or malic acid or mixtures thereof. These may be contained both within the actual fruit gum and also in a sugar-coating which takes place during a surface treatment.

Possible colorants are at least one coloring fruit or plant extract and/or at least one artificial colorant and/or at least one nature-identical colorant.

The release and glazing agents beeswax and vegetable oils which are used during the surface treatment may also be replaced by carnauba wax and other oil-containing agents or a combination thereof.

Optionally, substances of the composition may originate from controlled biological cultivation in accordance with EC regulations.

By virtue of the use of sugar-free substances as sweeteners, consumption of the fruit gum composition according to the invention is also possible for diabetics.

Further advantages of the embodiment emerge from the dependent claims.

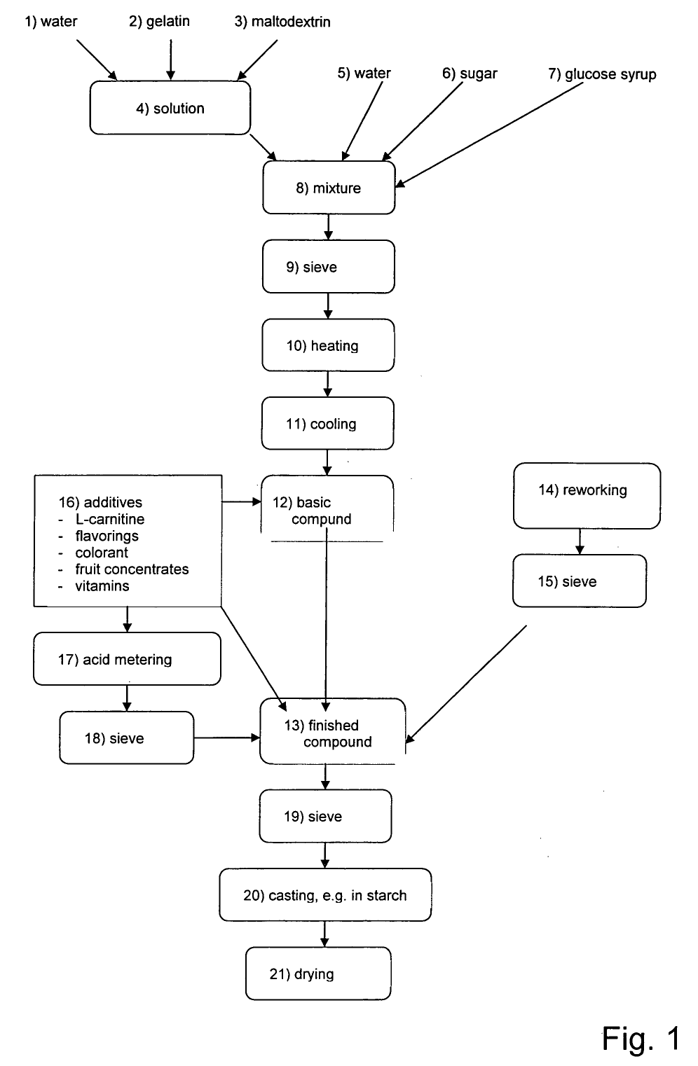

The invention will be described in more detail below with reference to a preparation example, as also shown in FIGS. 1 to 3. In the figures:

FIG. 1 shows a first part of the method for preparing the fruit gum composition according to the invention;

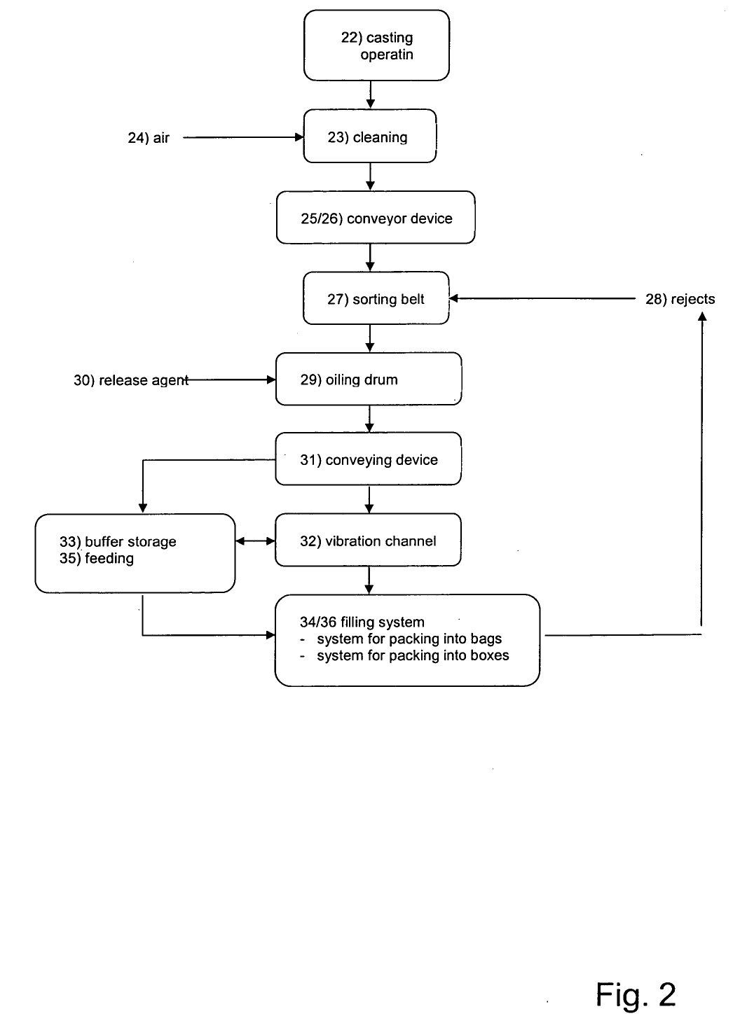

FIG. 2 shows a second part of the method for preparing the fruit gum composition according to the invention; and

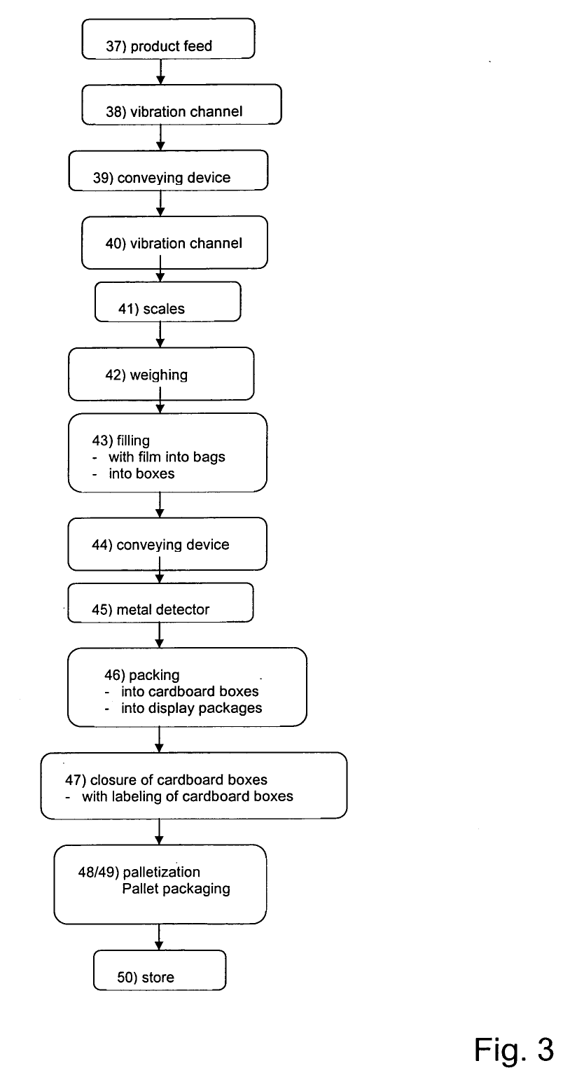

FIG. 3 shows a third part of the method for preparing the fruit gum composition according to the invention.

FIG. 1 shows a first part of the method for preparing the fruit gum composition according to the invention. Firstly, water 1, gelatin 2 and possibly other substances, such as maltodextrin 3, are mixed with hot water to form a gelatinizer solution. As an alternative or in addition to the gelatin 2, it is also possible to use pectin, agar agar and modified wheat starch, corn starch and/or potato starch and also gum arabic or mixtures thereof.

The raw materials water of solution 5, sugar 6 and glucose syrup 7 are added to the gelatinizer solution 4 and stirred by stirrers to form a homogeneous mixture 8.

This mixture 8 is pumped through a sieve 9 into a cooking system. By heating, the required dissolution temperature of the mixture is reached in a heating section 10.

The mixture is then passed through a cooling device 11 for the purpose of cooling, relaxation and degassing, and subsequently exists as a bubble-free basic compound.

The transparent and deaerated basic compound is then pumped out of a vacuum container by a pump.

Additional reworking steps allow the addition of further substances 14 by means of a sieve device 15 to form a finished compound 13 obtained from the basic compound 12.

Depending on the recipe, further additives 16 will preferably be added manually to the basic compound 12. These additives include in particular the L-carnitine having the formula C₇H₁₅NO₃ or C₁₈H₃₆N₂O₁₂, which exists in crystalline form.

Fruit acids, such as citric acid, malic acid and/or lactic acid for example, may also be added in order to achieve a sour flavor and to aid the gelling operation.

Natural or nature-identical flavorings are also added to the compound in order thus, by interaction with the acids, to achieve a typical fruit flavor.

Fruits and/or fruit juice concentrates may likewise be added in order to improve the taste and/or the natural appearance.

Coloring fruit and plant extracts or synthetically manufactured food colorants may be deemed necessary in order to color the product.

Such a flavoring of the compound takes place either manually by manual addition of the additives 16 or by machine by automatic metering.

The L-carnitine and further additives may alternatively be added directly to an acid solution by means of acid metering 17 and possibly a sieve 18 to the finished compound 13 or be added directly to the basic compound 12 or be added directly to the finished compound 13. Here, the addition takes place either manually with manual stirring using a whisk or stirrer or via automatic acid metering in order to achieve a homogeneous compound mixture.

In order to produce foam products or two-layer products, such as fruit gums with a foam part for example, part of the compound is foamed prior to casting by virtue of the addition of nitrogen and/or air by means of whipping machines.

The finished compound 13 is once again passed through a sieve 19 and poured into negative molds made of mold powder, such as corn starch and/or wheat starch for example. Casting 20 takes place by metering the liquid, warm casting compound by means of a piston or with the aid of nozzles.

The casting compound solidifies as a result of cooling and dries by losing moisture to the air and to the mold powder. After a certain time, the fruit gum pieces, which have then become solid, are mechanically separated from the mold powder and cleaned. A drying operation 21 is then carried out at a temperature of approx. 10-40° C. for a predefined period of time.

As an alternative to drying the cast fruit gum pieces, a powderless drying operation may take place without using mold powder by pouring the casting compound into premanufactured solid molds.

FIG. 2 shows a second part of the preparation method, in which a surface treatment of the product takes place. Firstly, the dried fruit gums are freed from the adhering mold powder by means of sieves and brushes 22. Additional cleaning 23 takes place by means of compressed air 24.

By means of an actuating conveyor 25, conveyor belts 26 and a sorting belt 27, sorting is then carried out in order to remove misshapen fruit gums (rejects 28). In order to produce a glazed surface and to prevent the fruit gums from sticking together, they are conveyed by the conveyor belts 25-27 to an oiling drum 29. There, a mixture of vegetable oils and beeswax 30 is added. This mixture is uniformly distributed over the fruit gums rotating in the drum, and gathers in the product surfaces in order to achieve oiling of the fruit gums.

As an alternative, the fruit gums may be sugar-coated by being treated briefly with steam on a lattice belt in order to melt their surface and make them sticky. They are then scattered with sugar crystals and/or a sugar/acid mixture in a rotating sieve drum so that the sugar crystals and/or the sugar/acid mixture adheres to the sticky surface of the fruit gums.

The souring agents used for the sugar/acid mixture are fumaric acid and/or malic acid and/or calcium citrate and/or calcilactol or mixtures thereof.

By means of the devices 31, 32, 33, 34, 35 and 36, the fruit gums are filled into bags and/or boxes.

FIG. 3 describes, in a third part of the preparation, the packaging of the fruit gums. If the fruit gums are buffer-stored in production baskets and production troughs, they are fed out of the buffer storage area 37 via vibration channels 38, 40, a steep conveyor 39, distributing plate scales 41 and filling scales 42, 43. The fruit gums filled into bags are passed underneath a metal detector 45 by a feed belt 44 for control purposes. The fruit gum bags or boxes are then packed into cardboard boxes/display packages 46 which are then closed 47, palletized 48 and stored in the store 50 in the form of pallet packages 49.

As an alternative to enriching a fruit gum composition with L-carnitine, it is also conceivable to enrich fruit sweets or sweets in general with L-carnitine.

All of the features disclosed in the application documents are to be regarded as essential to the invention. The person skilled in the art will be familiar with modifications thereto.

### KEY TO FIGURES

1) water
2) gelatin
3) maltodextrin
4) solution
5) water
6) sugar
7) glucose syrup
8) mixture
9) sieve
10) heating
11) cooling
12) basic compound
13) finished compound
14) reworking
15) sieve
16) additives
   L-carnitine
   flavorings
   colorant
   fruit concentrates
   vitamins
17) acid metering
18) sieve
19) sieve
20) casting, e.g. in starch
21) drying
22) casting operation
23) cleaning
24) air
25/26) conveyor device
27) sorting belt
28) rejects
29) oiling drum
30) release agent
31) conveying device
32) vibration channel
33) buffer storage
35) feeding
34/36) filling system
   system for packing into bags
   system for packing into boxes
37) product feed
38) vibration channel
39) conveying device
40) vibration channel
41) scales
42) weighing
43) filling
   with film into bags
   into boxes
44) conveying device
45) metal detector
46) packing
   into cardboard boxes
   into display packages
47) closure of cardboard boxes
   with labeling of cardboard boxes
48/49) palletization
   pallet packaging
50) store

1-17. (canceled)

18. A fruit gum composition, comprising:
at least one sweetener, at least one gelantizer and/or thickener, at least one souring agent, at least one colorant, at least one flavoring, and at least one release and glazing agent or sugar-coating agent as a surface-treatment agent,
characterized in that the fruit gum composition additionally comprises an L-carnitine in a form which is at least sometimes crystalline, having the formula C₇H₁₅NO₃ or C₁₈H₃₆N₂O₁₂, at least one L-carnitine complex, at least one L-carnitine complex salt, at least one mixture of substances containing L-carnitine, or at least one L-carnitine fumarate, or any combination thereof.

19. The fruit gum composition as claimed in claim 18, comprising L-carnitine as a crystalline tartrate having the formula C₁₋₈H₃₆N₂O₁₂ and having a molecular mass of 472.49 u.

20. The fruit gum composition as claimed in claim 18, comprising L-carnitine in pure crystalline form having a degree of purity of 99% and not more than 1% of residual components.

21. The fruit gum composition as claimed in claim 20, characterized in that the L-carnitine in pure crystalline form has the formula C₇H₁₅NO₃ and has a molecular mass of 161.20 u.

22. The fruit gum composition as claimed in claim 18, characterized in that the at least one mixture of substances containing L-carnitine is present as C₁₃H₁₂gmNO₁₀ and/or C₉H₁₈CINO₄.

23. The fruit gum composition as claimed in claim 18, characterized in that the sweetener is selected from the group consisting of glucose syrup, sugar, sucrose, fructose, sorbitol, sugar substitutes, isomalt, and any combinations thereof.

24. The fruit gum composition as claimed in claim 18, characterized in that the gelantinizer and/or thickener comprises gelatin, pectin, starch, modified starch, agar agar, gum arabic, or any combination thereof.

25. The fruit gum composition as claimed in claim 18, characterized in that the souring agent comprises citric acid, lactic acid, malic acid, or any combination thereof.

26. The fruit gum composition as claimed in claim 18, characterized in that the colorant comprises at least one coloring fruit or plant extract and/or at least one artificial color and/or at least one nature-identical colorant.

27. The fruit gum composition as claimed in claim 18, characterized in that the release and glazing agent comprises beeswax and/or carnauba wax and an oil-containing agent and the sugar-coating agent comprises sugar with one or more fruit acid and/or calcilactol.

28. The fruit gum composition as claimed in claim 18, characterized in that at least one of the substances of the composition originates from controlled biological cultivation in accordance with EC regulations.

29. A method of preparing a fruit gum composition containing at least one sweetener, at least one gelantizer and/or thickener, at least one souring agent, at least one colorant, at least one flavoring and at least one release and glazing agent or sugar-coating agent as a surface-treatment agent, characterized in that at least one of: L-carnitine in crystalline form, having a formula of C₇H₁₅NO₃ or C₁₈N₃₆N₂O₁₂, at least one L-carnitine salt, at least one L-carnitine salt mixture, at least one L-carnitine complex, at least one mixture of substances containing L-carnitine, at least one L-carnitine fumarate, is added to the fruit gum composition.

30. The method as claimed in claim 29, characterized in that the L-carnitine is added in the form of a crystalline tartrate as C₁₈H₃₆NO₃ having a molecular mass of 472.49 u.

31. The method as claimed in claim 29, characterized in that the L-carnitine is added in pure crystalline from as C₇H₁₅NO₃ with a degree of purity of 99% and at most 1% of residual components, having a molecular mass of 161.20 u.

32. The use of a fruit gum composition as claimed in claim 18, for the manufacture of food supplements.
